(19) United States
(12) Patent Application Publication
(10) Pub. No.: US 2012/0318761 A1
(43) Pub. Date: Dec. 20, 2012

(54) PORTABLE TOOTHBRUSH HOLDER

(76) Inventor: Donald J. Volk, Turlock, CA (US)

(21) Appl. No.: 13/491,713

(22) Filed: Jun. 8, 2012

Related U.S. Application Data
(60) Provisional application No. 61/498,006, filed on Jun. 17, 2011.

(51) Int. Cl. A47K 1/08; B23P 11/00

(52) U.S. Cl. 211/65; 29/426.2

(57) ABSTRACT

A portable toothbrush holder transformable between a first, storage state and a second, erected state, the portable toothbrush holder having a base component having a spindle connection feature; a top component having a spindle connection feature; and a spindle component; the base component, top component and spindle component being separable; and when the portable toothbrush holder is in the second, erected state when the spindle connection features of the base component and top component receive opposite ends of the spindle component.

### STATEMENT OF RELATED APPLICATIONS

This patent application is a non-provisional of and claims priority on U.S. Provisional Patent Application No. 61/498,006 having a filing date of 17 Jun. 2011.

### BACKGROUND OF THE INVENTION

1. Technical Field

This invention relates generally to containers and stands for holding and supporting elongated items and relates more specifically to disposable containers and stands for holding and supporting toothbrushes.

2. Prior Art

As society learned that harmful bacteria prevail on many bathroom surfaces, efforts began to keep toothbrushes, and in particular the moist bristle ends of toothbrushes, out of contact with these surfaces. The result of one such effort is the humble toothbrush holder.

Toothbrush holders prevent toothbrushes from contacting countertops and sink surfaces. Consequently, many homes today contain permanent toothbrush holders useful for suspending toothbrushes above countertops and away from harmful bacteria potentially residing thereon. The usefulness of a device for keeping toothbrushes off of sink surfaces, such as a toothbrush holder, is not only understood but also encouraged by the medical community.

Despite the acknowledged benefits of segregating one's toothbrush from bathroom surfaces, many users only employ a toothbrush holder when at home. That is, when travelling away from home, a user is often relegated to putting a toothbrush in a drinking glass or laying a toothbrush on a hotel washcloth, napkin or facial tissue to keep the toothbrush from coming in contact with a potentially unclean surface.

Therefore, what is needed in the art is a convenient, portable toothbrush holder that can be used to separate a toothbrush from a surface. Further, what is needed in the art is a portable toothbrush holder that can be transformed from a compact, travel state to an erected state useful for suspending one or more toothbrushes. Even further, what is needed in the art is a portable toothbrush holder that can be leveraged to place one or more toothbrushes in a proper position for drying, as repacking a toothbrush in a travel kit or suitcase before it has dried properly may promote bacteria growth.

Toothbrush holders are known, especially ceramic and plastic toothbrush holders present in the household bathroom. Toothbrush holders hold and support toothbrushes off of the counter for both health and aesthetic reasons. A vertically supported toothbrush dries more quickly and accumulates fewer germs than a toothbrush lying on the bathroom sink counter, and just looks better.

Hotels, inns, time shares, cruise ships, medical facilities and the like typically do not provide a toothbrush holder and patrons have a choice: prop their toothbrush up in a glass, leave the toothbrush lying on the counter, place the toothbrush on a towel, or dry the toothbrush and place it back in the toiletry kit. None of these options are particularly appealing.

Various toothbrush holders, disposable and non-disposable, have been developed. Several representative devices include:

U.S. Pat. No. 2,902,145 to Wagner, which discloses a flat, compact case having a plurality of apertures in an upper wall through which the shanks or handles of toothbrushes may be extended, the case standing upright on a suitable surface, and with the heads of the brushes extended above the top of the case. The device further contemplates the provision of a trough-shaped bottom for maintaining the brushes uniformly in place in the holder and which bottom is provided with openings for drainage purposes.

U.S. Pat. No. 3,233,743 to Di Tirro, which discloses a molded one piece box-like rack having a pair of parallel integral sides and back and adapted to be mounted in vertical planes. The spaced sides include cooperating pairs of downwardly inclined horizontally aligned slots for supporting a comb therein.

U.S. Pat. No. 5,687,855 to Heller, which discloses a disposable toothbrush holder, particularly for the convenience and hygiene of visitors in motels and hotels, holds toothbrushes upright, bristle end up, for sanitary drying, supported in circular openings in a convex upper portion supported by integrally-formed legs. The holders can be molded economically from recyclable plastic material, and can be nested together for space-efficient packaging.

U.S. Pat. No. 7,228,976 to Pretorius, which discloses a toothbrush holder including a single piece of sheet material including spaced first and second end edges. A single fold area across the sheet material defines a holder portion and a base portion. The holder portion terminates in the first end edge and has a length relative to the base portion to impart a smooth sloping curvature to the holder portion without fold lines when the toothbrush holder is deployed. The base portion terminates at the second end edge. At least one toothbrush receiving orifice in the holder portion is sized to receive the shaft of the toothbrush. A key extends outwardly from the second edge, and a lock for receiving the key is disposed in the holder portion. The lock is spaced from the first end edge to angle the base portion and to deploy and support the holder portion in a position spaced from the base portion with the orifice in the base portion elevated.

U.S. Design Pat. No. D570,144 to Scofield, which discloses an ornamental design for a disposable toothbrush holder that, in effect, has the appearance of a birdhouse or small house. The design has at least one hole in the “roof” of the design through which a toothbrush may be placed and held in a generally vertical orientation.

There is thus a need for an inexpensive disposable toothbrush holder for meeting the needs of hotels and other inns, cruise ships, travel kits, households, hospitals and other medical facilities, camps, schools, emergency management organizations, and the like.

### BRIEF SUMMARY OF THE INVENTION

Briefly, the disclosed embodiments, as well as features and aspects thereof, are directed towards providing a portable toothbrush holder. Embodiments of a portable toothbrush holder may be transformable between a first, compact state useful for transport and storage and a second, erected state useful for supporting one or more toothbrushes above a surface. For example, in a temporary lodging environment, embodiments of a portable toothbrush holder may be transformed into an erected state such that a user is provided with a convenient place for drying one or more toothbrushes while protecting them from potentially unclean, public surfaces.

One exemplary application of a portable toothbrush holder is in a temporary lodging environment. When a user arrives at a hotel, hospital, or other temporary lodging, for example, the user may have no convenient way to protect, store or dry a toothbrush. Embodiments of a portable toothbrush holder solve these common travel issues as they are easy to transport away from home in a first, compact travel state and assemble on site into a second, erected state. Once in the erected state, embodiments can receive a user's toothbrush, keep the toothbrush off the counter or sink surfaces and allow the toothbrush to dry properly.

One exemplary embodiment of a portable toothbrush holder includes a base, a top and a connecting spindle. The exemplary embodiment may be broken down into a first state for transportation or storage, and reassembled into a second, erected state for use. The base and top components may be configured to simultaneously receive the spindle component at its opposite ends to assemble the device into the erected, second state. Notably, when in the erected, second state, the portable toothbrush holder may be able to receive one or more toothbrushes such that the toothbrushes remain segregated from each other as well as the surface upon which the portable toothbrush holder resides.

When in the erected state, a received toothbrush may be retained by the top component of the exemplary portable toothbrush holder working in conjunction with the base component. That is, the top component may be able to receive a toothbrush through a toothbrush retention feature (such as a hole, for example) while the bottom component receives the end of the toothbrush handle into a complimentary toothbrush retention feature (such as a recess, for example). Once a toothbrush is received into an erected embodiment of a portable toothbrush holder, the neck of the received toothbrush may rest against the edge of the top component toothbrush retention feature while the distal end of toothbrush handle is lodged in the complimentary bottom component retention feature.

The retention feature of the base component of the exemplary embodiment may include a circular depression generally defined by an outer circumferential wall useful for receiving and retaining the handle of a toothbrush when the embodiment is in the erected state. Additionally, some embodiments of a portable toothbrush holder may include radial ridges positioned to split the circular depression of the base component into two or more sections, each section being able to receive and retain the handle of a toothbrush. Advantageously, by partitioning the circular depression of the base component with radial ridges or the like, a portable toothbrush holder may be able to receive the handle end of a toothbrush into each partitioned section such that a plurality of toothbrushes received into the embodiment are segregated from each other.

The retention feature of the base component in another exemplary embodiment may include individual depressions located so as to cooperate with a toothbrush retention feature (such as a hole, for example). In such an embodiment, the individual depressions are analogous to the two or more sections formed by the combination of the circular depression, the outer circumferential wall, and the radial ridges. For example, bottoms of the depressions correspond to the circular depression, one or more outer walls of the depressions correspond to the outer circumferential wall, and one or more side walls or inner walls of the depressions located between adjacent depressions correspond to the radial ridges.

Further, in certain embodiments, the base and/or top components may have a recess or valley feature, or features, useful for receiving the spindle when the device is in the first, disassembled state for transportation or storage, i.e. the storage state. Moreover, when in the storage state, the top component may communicate with the base component such that the spindle is securely held in the valley feature(s).

Notably, some embodiments of a portable toothbrush holder might be constructed of a material suitable for exposure to cleaning and sanitizing techniques. It is envisioned, however, that other embodiments may be constructed of a disposable or recyclable material.

These features, and other features and advantages of the present invention, will become more apparent to those of ordinary skill in the relevant art when the following detailed description of the preferred embodiments is read in conjunction with the appended drawings in which like reference numerals represent like components throughout the several views

### BRIEF DESCRIPTION OF THE DRAWINGS

FIG. 1 is a perspective view of an exemplary portable toothbrush holder, depicted in an erected state.

FIG. 2 is a perspective, cutaway view of the portable toothbrush holder of FIG. 1.

FIG. 3 is a perspective view of the exemplary portable toothbrush holder of FIG. 1, shown in a storage state.

FIG. 4 is a perspective, cutaway view of the portable toothbrush holder of FIG. 3.

### DETAILED DESCRIPTION OF PREFERRED EMBODIMENTS

The presently disclosed embodiments, as well as features and aspects thereof, are directed towards providing a portable toothbrush holder for keeping one or more toothbrushes from coming into contact with a counter or other surface. Embodiments of a portable toothbrush holder may be transformable between a first, compact state useful for transport and/or storage, and a second, erected state useful for supporting one or more toothbrushes above the surface.

As will become apparent from a review of the drawings and the following description, a portable toothbrush holder may be collapsed in a first state for ease of transport and/or storage and then reassembled in a second, erected state for use upon arrival at a destination. Notably, a portable toothbrush holder may prevent a user's toothbrush from coming in contact with bacteria, germs, dirt, and/or other contaminants that may be on a counter or sink surface upon which the portable toothbrush holder resides. Moreover, a portable toothbrush holder may also provide for a toothbrush to dry properly if left in the holder for a sufficient period of time. As is understood by one of ordinary skill in the art, proper drying of a toothbrush before storage may mitigate or prevent the growth of harmful bacteria, mold or fungus on the toothbrush.

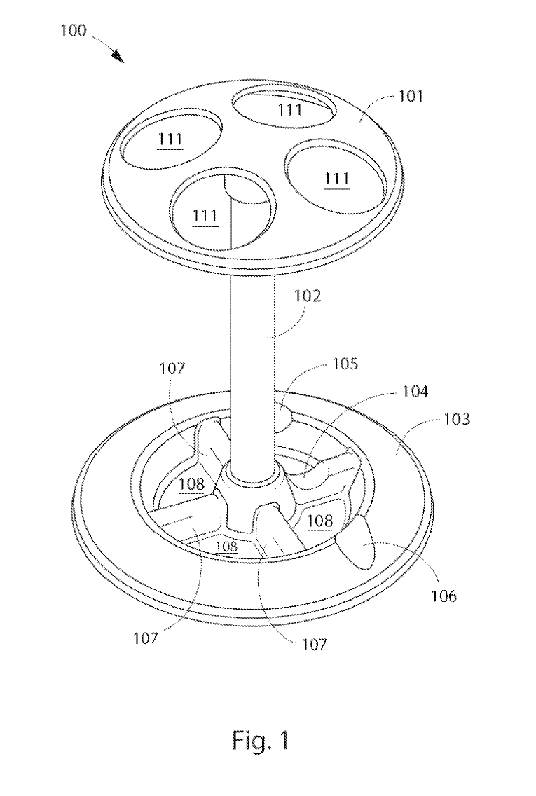

FIG. 1 is a perspective view of an exemplary portable toothbrush holder 100, depicted in an erected state. The holder has a base component 103, a top component 101 and a spindle component 102 for connecting base component 103 and top component 101.

In the particular embodiment shown in the FIGs., the spindle 102 may be an open ended, rigid tube having a circular cross-section, although one of ordinary skill in the art will recognize that a portable toothbrush holder is not limited to any particular construction or configuration of a spindle component 102. In other embodiments, the spindle 102 may be a solid preferably elongated component such as a solid rod. Whether tubular or solid, the cross section of the spindle 102 can be selected based on aesthetic preferences or structural preferences. For example, the cross section of the spindle 102 in the general horizontal plane when the portable toothbrush holder 100 is in the erected state and placed on a horizontal surface can be round, triangular, square, “I”-shaped, “+”-shaped, “L”-shaped, or any other regular or irregular polygon, as well as other shapes.

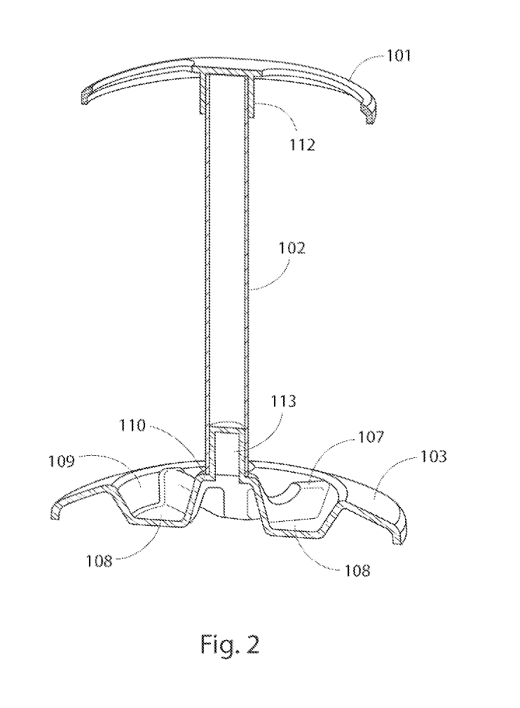

An end of the spindle 102 may be slidably received into a cavity defined by a top connection ring 112 (see FIG. 2) located on the underside of top component 101. The spindle 102 may fit snugly into the top connection ring 112 such that the top component 101 will not inadvertently decouple from the spindle 102 until the user desires to disassemble the portable toothbrush holder embodiment. It will be understood by one of ordinary skill in the art that this type of insertion fit, also known as a “slip fit” or “interference fit,” can provide a cost effective and simple method for connecting components and, as such, may be leveraged in some embodiments of a portable toothbrush holder.

It also will be understood that the top connection ring 112 need not be ring-shaped, particularly if the spindle 102 is not round in cross section. For example, if the spindle 102 is a solid “+”-shaped elongated member, the top connection ring 112 will have a corresponding “+”-shaped outer wall surrounding a “+”-shaped interior into which the “+”-shaped spindle 102 will fit. Similar corresponding configurations will be used for triangular, square, “I”-shaped, “L”-shaped, or other regular or irregular polygon, as well as other shapes of spindles 102.

However, it will also be understood by one of ordinary skill in the art that a portable toothbrush holder is not limited to leveraging insertion fits for connection of the various components; it is envisioned that some embodiments of a portable toothbrush holder may leverage other connection techniques for coupling and decoupling components such as, but not limited to, fasteners, magnets, etc. Similar to that which has been described relative to the connection between spindle 102 and top component 101, the opposite end of the spindle 102 may connect to the base component 103. In the exemplary FIG. 1 embodiment, the base connection ring 110 is slidably received into the inner diameter of the spindle 102.

Notably, the manners described above for connecting the spindle 102 to the top connection ring 112 and the base connection ring 110 are generally understood as “male to female” mechanical connections and are offered for exemplary purposes only. That is, it is envisioned that other means for connecting top component 101 and bottom component 103 to spindle 102 such as, but not limited to, threaded connections may be included in other embodiments of a portable toothbrush holder and, as such, the particular embodiment described relative to FIG. 1 will not limit the scope of the disclosure. For example, the spindle 102 may screw or clip onto the top component 101 and base component 103. Moreover, the top 101, base 103, and spindle 102 are shown and described as being circular. One of ordinary skill in the art will recognize that geometry of the various components may vary according to different embodiments of a portable toothbrush holder such as, for example, the outer circumference of the receiving feature of a component in other embodiments may be square, triangular, hexagonal or oval.

In the particular embodiment shown in the FIGs., the top component 101 is shown with a female mechanical connection and the bottom component 103 is shown with a male mechanical connection, while the spindle 102 has a male mechanical connection on a first end to cooperate with the top component 101 and a female mechanical connection on a second end to cooperate with the bottom component 103. If male and female mechanical connections are used, it will be understood that each of the components, top component 101, spindle 102, and bottom component 103, can have either a male or female mechanical connection, so long as the connections between the spindle 102 and the top component 101 and the bottom component 103 cooperate with each other.

Returning to the exemplary portable toothbrush holder embodiment shown in FIG. 1, the base component 103 features a circular depression defined by an outer circumferential wall 109. Advantageously, the depression feature defined by wall 109 creates a space in which to hold the handle of a toothbrush and prevent its sliding off of the base 103. Additionally, the exemplary embodiment includes a base component 103 featuring radial ridges 107 that effectively partition the depression defined by wall 109 into a plurality of sections 108 that may serve to segregate the handles of multiple toothbrushes, thus preventing the toothbrushes from coming into contact with one another. Notably, the top 101 may include either one or a plurality of openings 111 to receive the handles of one or a plurality of toothbrushes. Advantageously, these openings 111 allow the toothbrushes to be secured from the bristle ends such that the brushes rest in a substantially vertical position and remain segregated while drying.

Base component 103 has a shaped surface, which, in the illustrative embodiment shown, resembles somewhat an undulation or volcano. In the center of base component 103 is base connection ring 110. Extending radially from base connection ring 110 are radial ridges 107. Radial ridges 107 end at outer circumferential wall 109. Optional drainage holes (not shown) can be located in the valley between base connection ring 110 and outer circumferential wall 109 between radial ridges 107. A toothbrush placed in the holder 100 handle side down will rest in the valley between base connection ring 110 and outer circumferential wall 109 between radial ridges 107. More specifically, the outer surface of base connection ring 110 and outer circumferential wall 109 will guide the handle of a toothbrush into the valley where it will come to rest. The outer surface of base connection ring 110 and the outer circumferential wall 109 will maintain a toothbrush at a specific radial distance from the center of base component 103, and radial ridges 107 will maintain a toothbrush in a specific section of the base component 103. The radial distance defined by the valley is such that a toothbrush will be maintained at a specific generally upright angle so as to help prevent holder 100 from tipping over and to help direct water and or other liquids to any drainage holes (not shown) present. Such a distance can be variable and can be anywhere along base component 103 depending on the desired angle and the size of the holder 100. Radial ridges 107 help prevent multiple toothbrushes from touching each other within holder 100 and from moving about valley. The number of radial ridges 107 is variable, from none to as many will structurally fit on base component 103.

Base component 103 also can be structured from a molded planar piece of material or from a monolithic slab of material to have individual depressions as the sections 108. In such an embodiment, the individual depressions are analogous to the two or more sections 108 formed by the combination of the circular depression, the outer circumferential wall 109, and the radial ridges 107. For example, bottoms of the depressions correspond to the circular depression, one or more outer walls of the depressions correspond to the outer circumferential wall 109, and one or more side walls or inner walls of the depressions located between adjacent depressions correspond to the radial ridges 107. Thus, by analogy the radial ridges 107 that effectively partition the depression defined by wall 109 into a plurality of sections 108 are merely formed by the undepressed portion of the bottom component 103 between depressions, and the wall 109 is merely formed by the undepressed portion of the bottom component 103 between the depressions and the outer edge of the bottom component 103.

FIG. 2 is a perspective, cutaway view of the exemplary portable toothbrush holder 100. In the FIG. 2 illustration, spindle component 102 can be seen as inserted into a female receiving feature of top connection ring 112. Similarly, a male connecting feature 113 of bottom connection ring 110 can be seen inserted into the inner diameter of spindle component 102. Again, these connection mechanisms are offered for exemplary purposes only and will not limit the scope of the invention. Additionally, sections 108, as defined by partitions 107 through the base depression defined by wall 109, can be seen. Notably, it is envisioned that some embodiments of a portable toothbrush holder my include a drain hole or “weep” feature (not shown) in the bottom of sections 108 such that moisture may drain away from a received toothbrush.

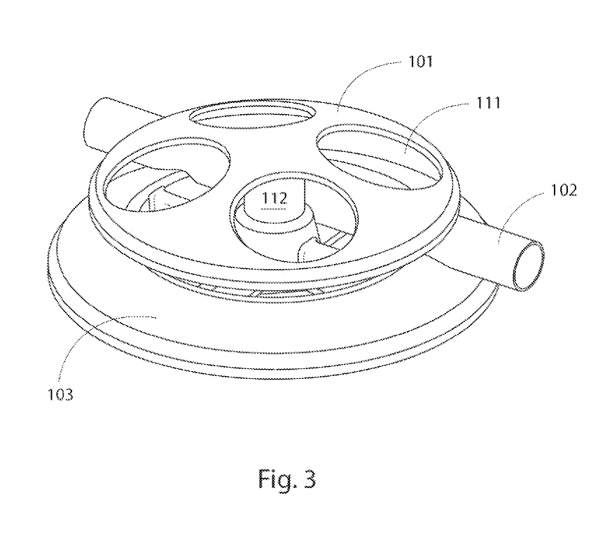

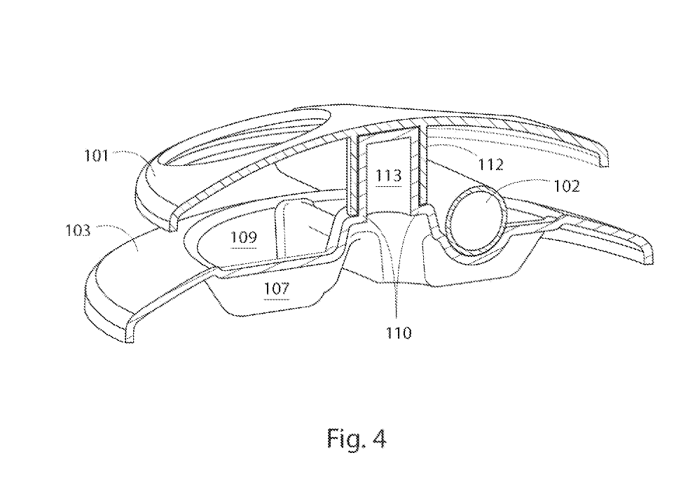

Turning now to FIG. 3, a perspective view of the exemplary portable toothbrush holder 100 is shown in a collapsed, storage state. As can be seen in FIG. 3, the top 101 has been disassembled from the spindle 102 and connected to the base 103 for storage or transportation. Advantageously, when in a storage state, an embodiment of a portable toothbrush holder is conveniently compact and easily transported. While in this travel state, the top component 101 of some embodiments may connect to the base 103 via the same insertion connections of the top and base connection rings 110, 112 described above (more easily seen in FIG. 4). Other embodiments of a portable toothbrush holder may have alternate means of connecting the top component 101 to the base component 103 including, but not limited to, screw connections, straps or clip connections. In yet other embodiments, the top component 101, the spindle 102, and the bottom component 103 remain unconnected in the storage state.

FIG. 4 is a perspective, cutaway view of the portable toothbrush holder 100 in a collapsed, storage state ready for transport. As can be seen in FIG. 4, the exemplary portable toothbrush holder 100 may accommodate the decoupled spindle 102 between top and bottom components 101, 103 while in the travel state. Briefly referring back to FIG. 1, the base of the exemplary embodiment 100 as shown includes valleys 104, 105, and 106 which may serve to accommodate the spindle 102 when the portable toothbrush holder 100 is in the storage state. In some embodiments, the valleys 104, 105, and 106 may be of a depth that allows the spindle 102 to be firmly compressed between the top component 101 and the valley 104, 105, and 106 such that the spindle 102 will not be dislodged during normal transport conditions. The valleys 104, 105, and 106 may be of a circular shape matching the radius of the spindle 102. A person of ordinary skill in the art, however, would recognize that in other embodiments the valleys 104, 105, and 106 may, by necessity, be of a shape more suited to accommodate an alternate geometry of the spindle 102. Valleys 104, 105, and 106 are optional as the top component 101, the spindle 102, and the bottom component 103 can remain unconnected in the storage state and merely placed loosely into a travel bag.

Alternatively, the bottom component 103 can be structured to be of a size and shape that is can fit within the top component 101 in a more compact storage state. For example, top component 101 and bottom component 103 can be of the same relative shape but with top component 101 having a slightly larger or smaller dimensional width and length, or diameter, dependent on the shape of the components 101, 103, such that the outer perimeter of bottom component 103 can fit within the inner perimeter of top component 101 or the outer perimeter of top component 101 can fit within the inner perimeter of bottom component 103, respectively, in the storage state, like a lid on a box.

It is an advantage of some embodiments of a portable toothbrush holder that the holder be constructed of a material that is safe for sanitizing and cleaning such as in a dishwasher. It would be apparent to one of ordinary skill in the art, however, that there are a variety of plastics and other similar materials well suited as a material of construction for a device that may be cleaned via exposure to high temperatures and/or steam and, as such, the particular material or materials used to construct a given portable toothbrush holder will not limit the scope of the disclosure. “Dishwasher safe” materials that may be used to construct a given portable toothbrush holder include, but are not limited to, polypropylene, polystyrene, and low-density polyethylene. Further, it is also envisioned that some embodiments of a portable toothbrush holder may be constructed of a material that one of ordinary skill in the art would recognize as disposable. That is, some embodiments of a portable toothbrush holder may be constructed of a material that cannot be properly sanitized and, as such, would be well suited for recycling or disposal after limited use. Materials for such a disposable embodiment include, but are not limited to, polyethylene terephthalate, high-density polyethylene, and paperboard.

In use, if the portable toothbrush holder is in its storage state, the user may decouple the top component 101 from the base component 103. With the portable toothbrush holder decoupled, the user may remove the spindle component 102 from the saddle features 104, 105, and 106 of the base component 103. Subsequently, the user may assemble the portable toothbrush holder by connecting the spindle component 102 with the top component 101. The user then may connect the spindle component 102 with the base component 103, and the portable toothbrush holder 100 is assembled and ready for use. Consequently, the user may insert one or more toothbrushes into the portable toothbrush holder, as was described relative to FIGS. 1-4. Notably, it would be apparent to one of ordinary skill in the art that a user of a portable toothbrush holder could store other items in a portable toothbrush holder in addition to, or in lieu of, toothbrushes. For example, it is envisioned that a user may store items including, but certainly not limited to, razors, pens, drinking straws, or cigars.

If the portable toothbrush holder 100 is in an assembled, erected state, the portable toothbrush holder may have one or more toothbrushes inserted into it. Consequently, toothbrushes may be removed from the portable toothbrush holder 100. Once toothbrushes are removed, the user may begin disassembly of the portable toothbrush holder 100 by decoupling the top component 101 from the spindle component 102. The user may decouple the spindle component 102 from the base component 103. Notably, an exemplary portable toothbrush holder may be completely deconstructed into its various components; however, one of ordinary skill in the art will recognize that not all embodiments of a portable toothbrush holder may require complete deconstruction in order to transform between states. The disconnected spindle 102 may be placed into the saddle features 104, 105, and 106 of the base component 103. The top component 101 may be coupled to the base component 103 (as seen in FIGS. 3-4). Further, the spindle 102 may be compressed into the saddle features 104, 105, and 106 by the top component 101 to secure it for storage and transport. Moreover, it is envisioned that in some embodiments of a portable toothbrush holder the top component 101 may include complimentary saddle features positioned to receive the spindle 102 in conjunction with the saddle features of the base component. As such, one of ordinary skill in the art will recognize that the number of saddle features, position of saddle features and/or shape of saddle features may vary according to embodiments of a portable toothbrush holder and, although such features may be novel, are not limiting on the scope of the present disclosure. Likewise, the saddle features are optional and embodiments of the invention may not include saddle features.

The assembled holder 100 preferably is between about 3.5 to 6.0 inches high and has diameters between about 2.5 to 4.0 inches, which is based on the size of the typical toothbrush and the typical bathroom counter. Larger and smaller dimensions are suitable.

The holder 100 can be made of many different materials, with plastics, papers, sugars, and starches being preferred. In an embodiment where the holder 100 is disposable, easily degrading materials are preferred, as well as thinner materials.

In use, the assembled holder 100 can be placed on a surface and be used for supporting toothbrushes. The holder 100 can be supplied by an innkeeper or the like to patrons, can be purchased by the ultimate user for personal use, can be given out or sold by commercial entities with advertising thereon for promotional purposes, as well as used in many other ways. Additionally, the holder 100 can be bagged, wrapped or otherwise packaged, for sanitary purposes, which covering also can include advertising, designs or the like. As the holder 100 can be broken down into its component parts, top component 101, spindle 102, and base component 103, and placed in the transportation or storage state, it is easy to ship and to store. At the location of use, the holder 100 can be assembled. After use, the holder 100 can be rinsed and reused, discarded or, preferably, recycled.

Certain steps in the processes described in this specification naturally precede others for the invention to function as described. However, the invention is not limited to the order of the steps described if such order or sequence does not alter the functionality of the invention. That is, it is recognized that some steps may be performed before, after, or in parallel with (substantially simultaneously with) other steps without departing from the scope and spirit of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method.

The present portable toothbrush holder has been described using detailed descriptions of embodiments thereof that are provided by way of example and are not intended to limit the scope of the system. The described embodiments comprise different features, not all of which are required in all embodiments of a portable toothbrush holder. Some embodiments of the invention utilize only some of the features or possible combinations of the features. Variations of the embodiments of the device that are described and embodiments of the invention comprising different combinations of features noted in the described embodiments will occur to persons of ordinary skill in the art.

It will be appreciated by persons of ordinary skill in the art that a portable toothbrush holder is not limited by what has been particularly shown and described herein above. Rather, the foregoing detailed description of the preferred embodiments and the appended figures have been presented only for illustrative and descriptive purposes. They are not intended to be exhaustive and are not intended to limit the scope and spirit of the invention. The embodiments were selected and described to best explain the principles of the invention and its practical applications. One skilled in the art will recognize that many variations can be made to the invention disclosed in this specification without departing from the scope and spirit of the invention.

What is claimed is:

1. A portable toothbrush holder transformable between a first, storage state and a second, erected state, the portable toothbrush holder comprising:
a) a base component having a spindle connection feature;
b) a top component having a spindle connection feature; and
c) a spindle component;
wherein the base component, top component and spindle component are separable; and
wherein the portable toothbrush holder is in the second, erected state when the spindle connection features of the base component and top component receive opposite ends of the spindle component.

2. The portable toothbrush holder of claim 1, wherein the top component comprises at least one toothbrush retention features.

3. The portable toothbrush holder of claim 2, wherein a toothbrush retention feature is comprised of a hole in the top component.

4. The portable toothbrush holder of claim 1, wherein the spindle component, when received by the spindle connection feature of the base component, is positioned substantially vertical to the base component.

5. The portable toothbrush holder of claim 4, wherein the top component is positioned substantially parallel to the base component when the top component spindle connection feature is in receipt of the spindle.

6. The portable toothbrush holder of claim 1, wherein the spindle connection features of the base component and top component are configured to couple the base component to the top component when the portable toothbrush holder is in the first, storage state.

7. The portable toothbrush holder of claim 6, wherein the base component further comprises at least one saddle feature configured to receive the spindle component.

8. The portable toothbrush holder of claim 7, wherein the spindle component may be received by the saddle feature and retained in place by the top component when the portable toothbrush holder is in the first, storage state.

9. The portable toothbrush holder of claim 1, wherein the base component further comprises a depression operable to receive at least one toothbrush handle.

10. The portable toothbrush holder of claim 9, wherein the base component further comprises at least one partition feature that serves to subdivide the depression into a plurality of cavities each operable to receive a toothbrush handle.

11. The portable toothbrush holder of claim 1, wherein a spindle connection feature is selected from the group consisting of a threaded connection, a slip fit connection, an interference connection, and a magnetic connection.

12. The portable toothbrush holder of claim 1, wherein the components comprise a material selected from the group consisting of polypropylene, polystyrene, and low-density polyethylene.

13. The portable toothbrush holder of claim 1, wherein the components comprise a material selected from the group consisting of polyethylene terephthalate, high-density polyethylene, and paperboard.

14. A method of using a portable toothbrush holder that comprises a base component, a top component and a spindle component, the portable toothbrush holder being transformable between a first, storage state and a second, erected state, the method comprising:
decoupling the top component from the base component, wherein the top component is coupled to the base component when the portable toothbrush holder is in a first, storage state;
transforming the portable toothbrush holder into a second, erected state by:
connecting an end of the spindle component with a spindle connection feature of the base component, wherein the spindle component is positioned substantially vertical to the base component; and
connecting the top component with the end of the spindle component that is distal to the base component such that the top component is positioned substantially parallel to the bottom component; and
placing a toothbrush through a toothbrush retention feature of the top component such that the handle of the toothbrush is received by a depression feature in the bottom component.

15. The method of claim 14, wherein the top component comprises a plurality of toothbrush retention features.

16. The method of claim 14, wherein the depression feature of the bottom component is subdivided into a plurality of cavities configured to receive the handle of a toothbrush.

17. The method of claim 14, the method further comprising:
removing one or more toothbrushes from the portable toothbrush holder; and
transforming the portable toothbrush holder into a first, storage state by:
decoupling the top component from the spindle component;
decoupling the spindle component from the bottom component;
placing the spindle component into at least one saddle feature of the bottom component; and
coupling the top component to the bottom component, wherein the top component secures the spindle in the at least one saddle feature of the bottom component.
